(19) United States
(12) Patent Application Publication
(10) Pub. No.: US 2013/0028091 A1
(43) Pub. Date: Jan. 31, 2013

(54) SYSTEM FOR CONTROLLING SWITCH DEVICES, AND DEVICE AND METHOD FOR CONTROLLING SYSTEM CONFIGURATION

(71) Applicants: Lei SUN, Tokyo (JP); Kentaro Sonoda, Tokyo (JP); Kazuya Suzuki, Tokyo (JP); Hideyuki Shimonishi, Tokyo (JP); Shuji Ishii, Tokyo (JP)

(72) Inventors: Lei SUN, Tokyo (JP); Kentaro Sonoda, Tokyo (JP); Kazuya Suzuki, Tokyo (JP); Hideyuki Shimonishi, Tokyo (JP); Shuji Ishii, Tokyo (JP)

(73) Assignee: NEC Corporation, Tokyo (JP)

(21) Appl. No.: 13/402,776

(22) Filed: Feb. 22, 2012

(30) Foreign Application Priority Data
Jul. 27, 2011 (JP) 2011-163883

(51) Int. Cl. H04L 12/24

(52) U.S. Cl. 370/236

(57) ABSTRACT

A control device which controls configuration of a control system including a plurality of control nodes, wherein at least one control node controls a plurality of switch devices by sending packet handling rules, includes: a monitor which monitors workloads of control nodes in use, each control node in use controlling at least one switch device; and a controller which changes count of control nodes in use based on workload information monitored.

### INCORPORATION BY REFERENCE

This application is based upon and claims the benefit of priority from Japanese Patent Application No. 2011-163883, filed on Jul. 27, 2011, the disclosure of which is incorporated herein in its entirety by reference.

### BACKGROUND

The present invention relates to a software defined networking (SDN) technology and, more particularly, to a system for controlling switch devices as well as to a device and method for controlling the configuration of the system.

In recent years, a new network technology called software defined networking (SDN) has been proposed, and development of network platforms, such as OpenFlow, for example, has proceeded as open sources (e.g. N. Mckeown et al., “OpenFlow: Enabling Innovation in Campus Networks,” ACM SIGCOMM Computer Communication Review, 38(2): 69-74, April 2008). The basic idea of the OpenFlow technology is that a data plane and a control plane are separated and thereby can be evolved independently. This separation enables a switch to change from a closed system to an open programmable platform. For a control system for controlling switches, various proposals are made as follows.

N. Gude et al., “NOX: Towards an operating system for networks,” (ACM SIGCOMM Computer Communication Review, July 2008) proposes an “operating system” for networks called NOX, in which an OpenFlow controller is provided as a single process program operating on a central control server. K. Koponen et al., “Onix A Distributed Control Platform for Large-scale Production Networks,” (In the Proc. of the 9th USENIX Symposium on Operating System Design and Implementation (OSDI 10), Vancouver, Canada, October 2010) proposes a distributed control platform (Onix) which operates on a cluster composed of one or more physical servers. Moreover, A. Tootocian and Y. Ganjali, “HyperFlow: A Distributed Control Plane for OpenFlow,” (In the Proc. of NSDI Internet Network Management Workshop/Workshop on Research on Enterprise Networking (INM/WREN), San Jose, Calif., USA, April 2010) proposes a distributed control plane (HyperFlow) which, based on the above-mentioned NOX platform, connects a plurality of NOX control servers to form a distributed controller cluster.

A system in which a distributed controller is implemented on a cluster composed of a plurality of servers particularly has advantages such as providing scalable controller capability.

However, in such a system in which a distributed controller is implemented on a cluster of a plurality of servers, power consumption on the control plane increases in proportion to the number of servers, and a challenge of reducing power consumption, which has been regarded increasingly important recently, cannot be solved.

### SUMMARY

Accordingly, an object of the present invention is to provide a control system that can reduce power consumption on the control plane in software defined networking (SDN) without deteriorating performance, as well as a device and method for controlling the configuration of the system.

According to the present invention, a control device which controls configuration of a control system including a plurality of control nodes, wherein at least one control node controls a plurality of switch devices by sending packet handling rules, includes: a monitor for monitoring workloads of control nodes in use, each control node in use controlling at least one switch device; and a controller which changes count of control nodes in use based on workload information monitored.

According to the present invention, a control system comprising a plurality of control nodes, wherein at least one control node controls a plurality of switch devices by sending packet handling rules, further includes: a monitor for monitoring workloads of control nodes in use, each control node in use controlling at least one switch device; and a controller which changes count of control nodes in use based on workload information monitored.

According to the present invention, a control method for controlling configuration of a control system including a plurality of control nodes, wherein at least one control node controls a plurality of switch devices by sending packet handling rules, includes the steps of monitoring workloads of control nodes in use, each control node in use controlling at least one switch device; and changing count of control nodes in use based on workload information monitored.

According to the present invention, the frequency of use of control nodes is changed based upon workload information on the control nodes, whereby it is possible to reduce power consumption on the control plane in software defined networking (SDN) without deteriorating performance.

### BRIEF DESCRIPTION OF THE DRAWINGS

FIG. 1 is a schematic diagram of a software defined networking (SDN) system using a control system including a distributed controller cluster, according to a first illustrative embodiment of the present invention.

FIG. 2 is a schematic diagram for briefly describing a method for configuring the distributed control system according to the present illustrative embodiment.

FIG. 3 is a block diagram showing an example of the functional configuration of the control system according to the present illustrative embodiment.

FIG. 4 is a flowchart showing an example of a method for controlling the configuration of the distributed controller cluster according to the present illustrative embodiment.

### DETAILED DESCRIPTION

According to illustrative embodiments, the frequency of use of cluster nodes included in a controller cluster on a control plane is changed depending on control load, allowing reduced power consumption on the control plane without deteriorating control performance of the control plane. Hereinafter, a detailed description will be given of an illustrative embodiment of the present invention and a specific configuration example, taking OpenFlow as an example of software defined networking (SDN).

### 1. System

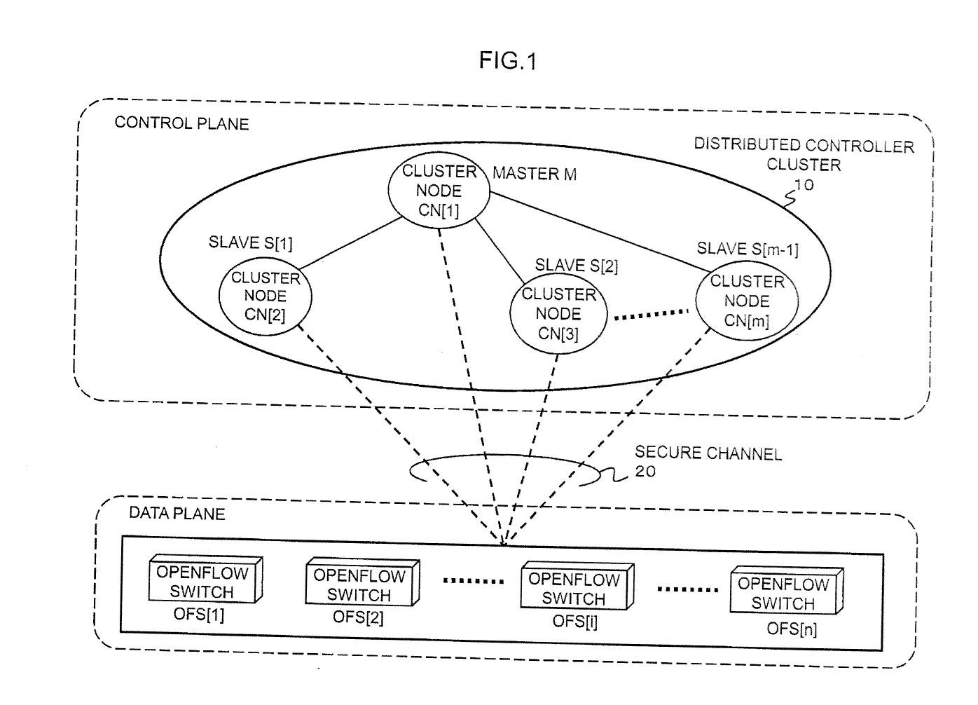

Referring to FIG. 1, an OpenFlow system is separated into a control plane and a data plane. Here, it is assumed that the data plane is implemented on n (n>1) OpenFlow switches OFS[1] to OFS[n] and that the control plane is implemented on a distributed controller cluster 10 that controls the OpenFlow switches OFS[1] to OFS[n] according to packet handling rules. The distributed controller cluster 10 constitutes a subnet on the control plane. Here, it is assumed that m (m>1) cluster nodes CN[1] to CN[m] can be used.

Each of the cluster nodes CN[1] to CN[m] can connect to one or more OpenFlow switches through a secure channel 20 and programs a flow table of the OpenFlow switch it has connected to. Each cluster node is a server as a physical control device and has a function of monitoring workload on an OpenFlow controller of the own node and a function of boot-up/shutdown a controller and connecting to/disconnecting from a secure channel in accordance with external control, which will be described later.

According to the present illustrative embodiment, one of the m (m>1) cluster nodes CN[1] to CN[m] functions as a master node M, and the remaining m−1 cluster nodes function as slave nodes S[1] to S[m−1]. Depending on control load on the own node, the master node M dynamically performs actions such as booting up/shutting down an arbitrary slave node, connecting/disconnecting a secure channel with the slave node in question, and taking over OpenFlow switch control processing to/from the slave node in question. Since the master node M operates nonstop, it is preferable that a particular one cluster node be predetermined as the master node M. In FIG. 1, the cluster node CN[1] is the master node M. However, it is also possible to assign a function of the master node to another arbitrary cluster node. Hereinafter, a description will be given from a functional viewpoint, assuming that the distributed controller cluster 10 includes a single master node M and at least one slave node (S[1] to S[m−1]).

### 2. System Operation

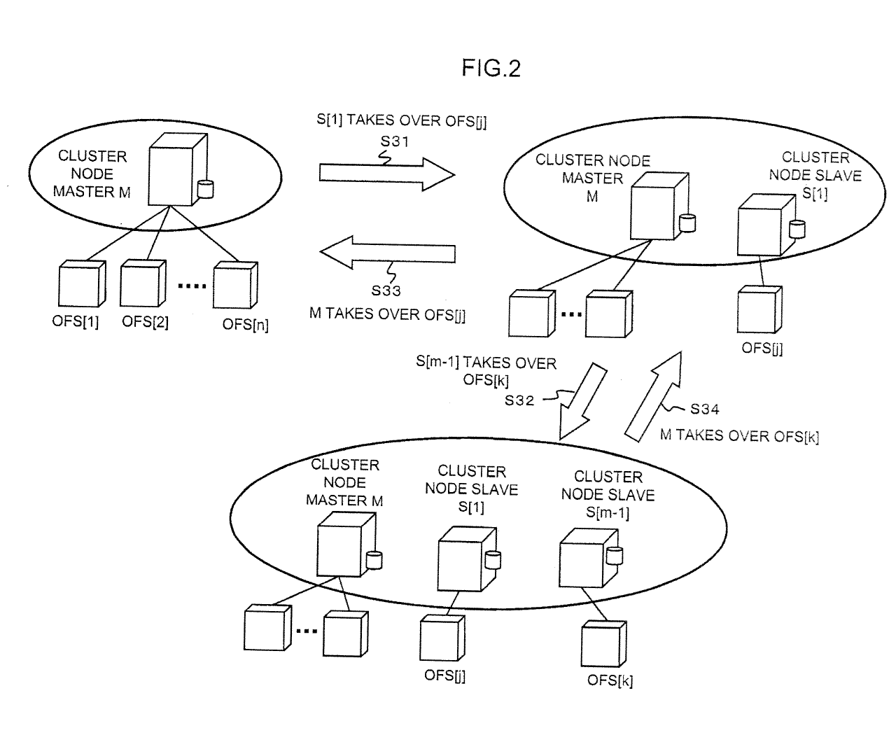

Referring to FIG. 2, in the control system according to the present illustrative embodiment, the single master node M monitors workload on each cluster node and, depending on the state of workload, takes over control to or from a slave node. For example, it is assumed that the master node M alone controls the OpenFlow switches OFS[1] to OFS[n] and periodically monitors workload on the own node.

When the possibility is high that the control load on the master node M exceeds the throughput of the master node M, the master node M selects and boots up a slave node (assumed to be the slave node S[1]) that is not used to control any OpenFlow switch and takes over control of an OpenFlow switch OFS[j] making the heaviest workload to the slave node S[1] (Operation S31). Thus, the slave node S[1] takes over control of the OpenFlow switch OFS[j], and the workload on the master node M is reduced by that amount. The master node M and slave node S[1] have their respective management databases synchronize with each other and thus constitute a distributed management database cluster. The master node M monitors the states of workload on the own node and slave node S[1] and, when the possibility becomes high that the control load on the master node M exceeds the throughput thereof, takes over control of an OpenFlow switch OFS[k] making the heaviest workload to another unused slave node (assumed to be the slave node S[m−1]) (Operation S32). Thus, the slave node S[m−1] takes over control of the OpenFlow switch OFS[k], and the workload on the master node M is reduced by that amount. Similarly thereafter, such takeover processing is repeated, in which each time the possibility becomes high that the control load on the master node M exceeds the throughput thereof, the master node M takes over control of an OpenFlow switch OFS making the heaviest workload to another unused slave node S.

For another method, it is also possible that each time the possibility becomes high that the control load on the master node M exceeds the throughput thereof, the master node M sequentially takes over control of an OpenFlow switch OFS to a slave node within the range of the throughput of the slave node. In this case, for example, when the master node M determines that the possibility is high that workload on the slave node S[1] exceeds its throughput, the master node M selects and boots up the new unused slave node S[m−1] and takes over control of the OpenFlow switch OFS[k] making the heaviest workload to the slave node S[m−1] (Operation S32). Similarly thereafter, the master node M monitors the states of workload on the own node and slave nodes S[1] and S[m−1] and, when the possibility becomes high that the control loads on the master node M and currently used slave nodes exceed the throughputs thereof, boots up another unused slave node and takes over control of an OpenFlow switch OFS making the heaviest workload to this new slave node.

Conversely, when the control load on the master node M decreases to a level low enough, the master node M selects a slave node that is operating with the lightest workload among those slave nodes in use and, if there is room to process control of an OpenFlow switch that has been performed by the selected slave node, takes over this control and shuts down this slave node (Operation S33 or S34). Shutting down an unused slave node reduces power consumption on the control plane.

The number of salve nodes operating in the distributed controller cluster 10 is increased or decreased as described above, whereby it is possible to reduce power consumption on the control plane without deteriorating control performance.

### 3. Functional Configuration of Cluster Node

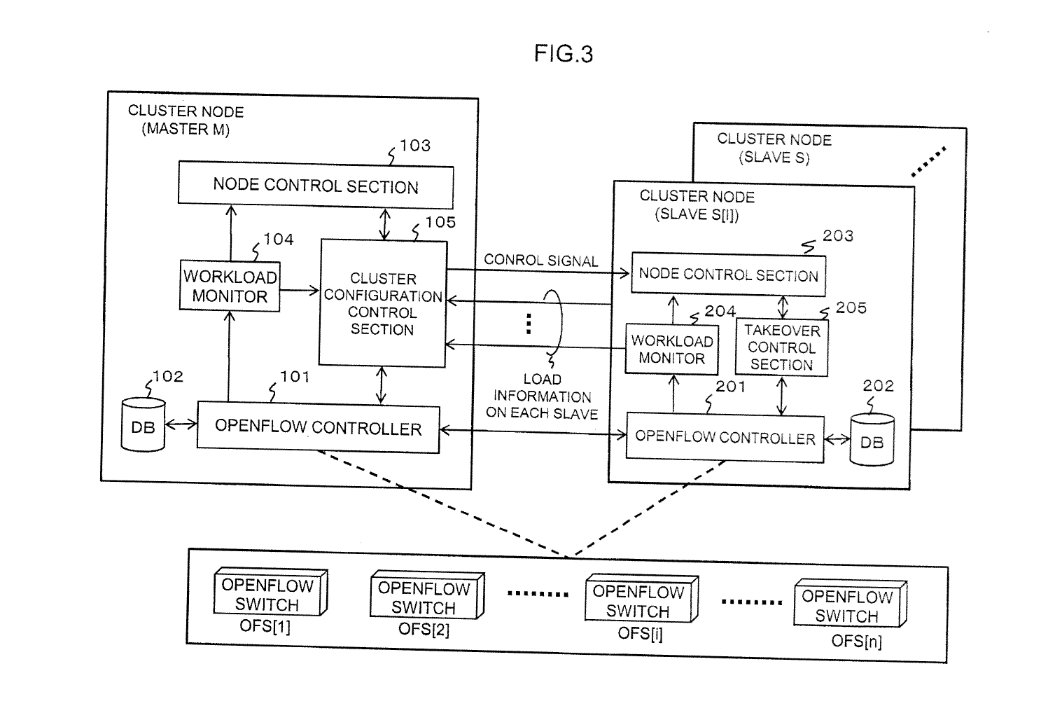

Referring to FIG. 3, the master node M includes an OpenFlow controller 101 that controls an OpenFlow switch and a management database 102 that stores management information, and is further functionally provided with a node control section 103 that controls operation of the master node M, a workload monitor 104 that monitors workload on the OpenFlow controller 101, and a cluster configuration control section 105 that dynamically makes cluster node deployment. The workload monitor 104 may periodically detect the control load on the OpenFlow controller 101 and, based on their average value and tendency to increase or decrease, generate a future estimated workload as workload information. The cluster configuration control section 105 stores a predetermined re-configuration threshold value High-TH beforehand and has a function of configuring a cluster, which will be described later, and a function of taking over control of an OpenFlow switch to/from a slave node. The re-configuration threshold value High-TH is a value predetermined depending on the throughput of the OpenFlow controller 101 of the master node M.

Note that a communication function is not shown in FIG. 3. Moreover, the respective functions of the OpenFlow controller 101, node control section 103, workload monitor 104, and cluster configuration control section 105 can be implemented by executing programs stored in a memory (not shown) on a computer (program-controlled processor).

The slave node (i=1, 2, m−1) includes an OpenFlow controller 201 that controls an OpenFlow switch and a management database 202 that stores information to be locally used, and is further functionally provided with a node control section 203 that controls operation of the slave node, a workload monitor 204 that monitors workload on the OpenFlow controller 201, and a takeover control section 205 that controls takeover of OpenFlow switch control to/from the master node M. The workload monitor 204 may periodically detect the control load on the OpenFlow controller 201 and, based on their average value and tendency to increase or decrease, generate a future estimated workload as workload information. The node control section 203 of each slave node periodically reports workload information on the own node to the master node M. Note that a figure of a communication function is omitted in FIG. 3. Moreover, the respective functions of the OpenFlow controller 201, node control section 203, workload monitor 204, and takeover control section 205 can be implemented by executing programs stored in a memory (not shown) on a computer (program-controlled processor).

The cluster configuration control section 105 of the master node M manages all available slave nodes as well as those slave nodes in use and, while monitoring workload information on the own node from the workload monitor 104 and workload information received from each of the slave nodes in use, exchanges a control signal with a selected slave node and takes over database information to the slave node. Hereinafter, a description will be given of cluster configuration control performed by the master node M.

### 4. Cluster Node Deployment Control

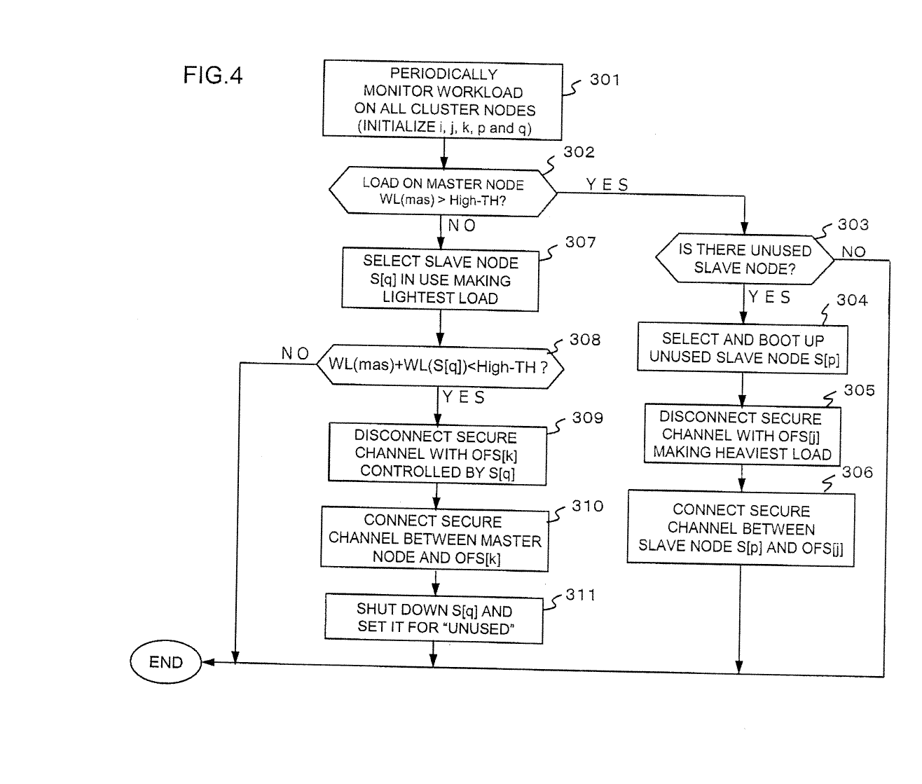

Referring to FIG. 4, the cluster configuration control section 105 of the master node M manages the number (m−1) of all available slave nodes and the number of slave nodes currently in use, as well as their identification information. The cluster configuration control section 105 periodically monitors workload information WL(mas) detected by the workload monitor 104 and workload information WL(S[•]) received from each slave node in use (Operation 301). Upon acquisition of the workload information, the cluster configuration control section 105 determines whether or not the workload information WL(mas) on the master node M exceeds the reconfiguration threshold value High-TH (Operation 302).

### 4.1) Addition of Slave Node

When the workload information W (mas) exceeds the re-configuration threshold value High-TH (Operation 302: YES), the cluster configuration control section 105 determines whether or not there is an unused slave node, based on whether or not the number of the slave nodes currently in use is smaller than m−1, the number of all slave nodes (Operation 303).

If there is an unused slave node (Operation 303: YES), the cluster configuration control section 105 selects and boots up one unused slave node S[p](Operation 304). For example, to boot up the unused slave node S[p], the cluster configuration control section 105 sends a wake-on-LAN magic packet to the slave node S[p]. Upon receipt of the wake-on-LAN magic packet, the node control section 203 of the slave node S[p] starts the takeover control section 205, thereby starting taking over OpenFlow switch control from the master node M. The cluster configuration control section 105 sends an ICMP echo packet and receives a response from the slave node S[p], thereby confirming that the slave node S[p] has normally started. Upon confirmation of this normal start, the cluster configuration control section 105 establishes a TCP connection between the slave node S[p] and master node M and starts an upper layer application such as path resolution or topology service based on this TCP connection.

Upon start of the slave node S[p], the cluster configuration control section 105 selects, among OpenFlow switches currently controlled by the OpenFlow controller 101, an OpenFlow switch making the heaviest workload (assumed to be an OpenFlow switch OFS[j]) and disconnects a secure channel with this OpenFlow switch OFS[j] (Operation 305). At the same time, the cluster configuration control section 105 instructs the slave node S[p] to connect a secure channel to the OpenFlow switch OFS[j] (Operation 306) and sets this slave node S[p] for “in use.” In this manner, the takeover control section 205 of the slave node S[p] takes over control of the OpenFlow switch OFS[j] from the master node M. If there is no unused slave node (Operation 303: NO), or when the takeover of control of the OpenFlow switch OFS[j] is completed, the cluster configuration control section 105 finishes the processing.

### 4.2) Removal of Slave Node

When the workload information WL(mas) is not larger than the re-configuration threshold value High-TH (Operation 302: NO), the cluster configuration control section 105 refers to the workload information reported from the slave nodes in use and selects a slave node S[q] making the lightest workload (Operation 307). Subsequently, the cluster configuration control section 105 determines whether or not the result of adding the workload information WL(S[q]) on the slave node S[q] to the current workload information WL(mas) is smaller than the re-configuration threshold value High-TH (Operation 308). If WL(mas)+WL(S[q])<High-TH (Operation 308: YES), then the cluster configuration control section 105 disconnects secure channels with all OpenFlow switches (assumed to be an OpenFlow switch OFS[k]) controlled by the slave node S[q] (Operation 309) and also connects a secure channel between the OpenFlow controller 101 of the master node M and the OpenFlow switch OFS[k] (Operation 310). The cluster configuration control section 105 then finishes all applications related to the slave node S[q], sends a shutdown instruction to the slave node S[q], and sets the slave node S[q] for “unused” after confirming that no response is sent back to an ICMP echo packet (Operation 311).

As described above, the master node M, when its own throughput has allowance, takes over OpenFlow switch control from a slave node that is operating with the lightest workload and shuts down this slave node, whereby it is possible to reduce power consumption on the control plane. When the shutdown of the salve node is completed, or when WL(mas)+WL(S[q])≧High−TH (Operation 308: NO), the cluster configuration control section 105 finishes the processing.

Note that the database 102 of the master node M and the database 202 of each slave node Sk[i] are updated in such a manner that they synchronize with each other. That is, when a new flow entry or a change in current flow entries is made to the database 202 of the slave node SW, it reflects on the database 102 of the master node M. Conversely, when a new flow entry or a change in current flow entries is made to the database 102 of the master node M, it reflects on the database 202 of the slave node S[i].

### 5. Effects

As described above, according to the present illustrative embodiment, the master node M dynamically boots up/shuts down an arbitrary slave node and takes over OpenFlow switch control to/from this slave node, depending on the control load on the own node. That is, the number of slave nodes operating in the distributed controller cluster 10 is increased or decreased depending on the state of workload, whereby it is possible to reduce power consumption on the control plane without deteriorating control performance.

### 6. Other Illustrative Embodiments

In the above-described illustrative embodiment, the cluster configuration control section 105 is provided to the master node M as shown in FIG. 3. However, the present invention is not limited to this. For another illustrative embodiment, it is also possible to provide the functionality of the cluster configuration control section 105 to another node different from cluster nodes within the same cluster. In this case, basic operations are similar to those described in the above illustrative embodiment, except for communication between the cluster configuration control node and master node M.

### 7. Supplementary Notes

The present invention is applicable to a control system on a distributed controller plane in software defined networking (SDN). A cluster node as described above may be implemented by a program running on a computer. Part or all of the above-described illustrative embodiments can also be described as, but are not limited to, the following additional statements.

1. A non-transitory computer readable program for controlling configuration of a control system including a plurality of control nodes, wherein at least one control node controls a plurality of switch devices by sending packet handling rules, which, when executed by a processor, performs a method comprising:

monitoring workloads of control nodes in use, each control node in use controlling at least one switch device; and

changing count of control nodes in use based on workload information monitored.

2. The program according to additional statement 1, wherein the count of control nodes in use other than one control node of the plurality of control nodes is changed based on workload information of the one control node.
3. The program according to additional statement 2, wherein the one control node is a nonstop node which operates at all times.
4. The program according to additional statement 2, wherein when the workload information of the one control node exceeds a predetermined workload reference value, an unused control node is booted up before the control node booted takes over control of at least one switch device from the one control node.
5. The program according to additional statement 2, wherein when the workload information of the one control node decreases below a predetermined workload reference value, the one control node takes over control of at least one switch device from a control node in use before the control node in use is shut down.

The present invention may be embodied in other specific forms without departing from the spirit or essential characteristics thereof. The above-described illustrative embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A control device which controls configuration of a control system including a plurality of control nodes, wherein at least one control node controls a plurality of switch devices by sending packet handling rules, comprising:
a monitor for monitoring workloads of control nodes in use, each control node in use controlling at least one switch device; and
a controller which changes count of control nodes in use based on workload information monitored.

2. The control device according to claim 1, wherein the controller changes count of control nodes in use other than one control node of the plurality of control nodes based on workload information of the one control node.

3. The control device according to claim 2, wherein the one control node comprises a nonstop node which operates at all times.

4. The control device according to claim 2, wherein when the workload information of the one control node exceeds a predetermined workload reference value, the controller boots up an unused control node and controls such that the control node booted takes over control of at least one switch device from the one control node.

5. The control device according to claim 2, wherein when the workload information of the one control node decreases below a predetermined workload reference value, the controller controls such that the one control node takes over control of at least one switch device from a control node in use before the control node in use is shut down.

6. A control system comprising a plurality of control nodes, wherein at least one control node controls a plurality of switch devices by sending packet handling rules, further comprising:
a monitor for monitoring workloads of control nodes in use, each control node in use controlling at least one switch device; and
a controller which changes count of control nodes in use based on workload information monitored.

7. The control system according to claim 6, wherein the monitor and the controller are provided in a nonstop node which comprises one of the plurality of control nodes, wherein the nonstop node operates at all times.

8. The control system according to claim 7, wherein the controller changes count of control nodes in use other than the nonstop node based on workload information of the nonstop node.

9. The control system according to claim 7, wherein when the workload information of the nonstop node exceeds a predetermined workload reference value, the controller boots up an unused control node and controls such that the control node booted takes over control of at least one switch device from the nonstop node.

10. The control system according to claim 7, wherein when the workload information of the nonstop node decreases below a predetermined workload reference value, the controller controls such that the nonstop node takes over control of at least one switch device from a control node in use before the control node in use is shut down.

11. A control method for controlling configuration of a control system including a plurality of control nodes, wherein at least one control node controls a plurality of switch devices by sending packet handling rules, comprising:
monitoring workloads of control nodes in use, each control node in use controlling at least one switch device; and
changing count of control nodes in use based on workload information monitored.

12. The control method according to claim 11, wherein the count of control nodes in use other than one control node of the plurality of control nodes is changed based on workload information of the one control node.

13. The control method according to claim 12, wherein the one control node comprises a nonstop node which operates at all times.

14. The control method according to claim 12, wherein when the workload information of the one control node exceeds a predetermined workload reference value, an unused control node is booted up before the control node booted takes over control of at least one switch device from the one control node.

15. The control method according to claim 12, wherein when the workload information of the one control node decreases below a predetermined workload reference value, the one control node takes over control of at least one switch device from a control node in use before the control node in use is shut down.

16. A control node comprising the control device according to claim 1.

17. A control node comprising the control device according to claim 2.

18. A control node comprising the control device according to claim 3.

19. A control node comprising the control device according to claim 4.

20. A control node comprising the control device according to claim 5.
